(19) United States
(12) Patent Application Publication
(10) Pub. No.: US 2020/0363698 A1
(43) Pub. Date: Nov. 19, 2020

(54) STOP MODULE FOR CINEMATOGRAPHIC CAMERA SYSTEM

(71) Applicant: ARNOLD & RICHTER CINE TECHNIK GMBH & CO. BETRIEBS KG, Munich (DE)

(72) Inventor: Jan KASTER, Feldafing (DE)

(73) Assignee: ARNOLD & RICHTER CINE TECHNIK GMBH & CO. BETRIEBS KG, Munich (DE)

(21) Appl. No.: 16/874,591

(22) Filed: May 14, 2020

(30) Foreign Application Priority Data
May 15, 2019 (DE) 10 2019 112 679.1

(51) Int. Cl. G03B 9/02; B32B 7/12; B32B 7/08; B32B 3/06; B32B 9/04; H04N 5/225; H04N 5/238

(52) U.S. Cl. CPC G03B 9/02; B32B 7/12; B32B 7/08; B32B 3/06; B32B 9/045; B32B 2551/00; H04N 5/2254; H04N 5/238; B32B 2250/40; B32B 2307/41; H04N 5/2253

(57) ABSTRACT

Disclosed is a stop module for a camera system, wherein the stop module has a multilayered composite construction forming a stop module opening

This application claims priority of DE 10 2019 112 679.7, filed May 15, 2019, the content of which is incorporated herein in its entirety.

### TECHNICAL FIELD

The present invention relates to embodiments of a stop module for a camera system, in particular a cinematographic camera system. The present invention furthermore relates to embodiments of a camera system comprising a stop module, in particular embodiments of a cinematographic camera system comprising a stop module.

### BACKGROUND

The document WO 2006/012859 A2 discloses a cinematographic camera system, for example.

A camera system of this type comprises a camera unit for capturing still and/or moving images of an object, wherein the camera unit has an optical system comprising at least one lens and also an image sensor. Via the lens, the light is captured and fed to the image sensor. The image sensor is connected to an image signal evaluation unit, which reads the image sensor and, as a result, produces digital data that are indicative of the still and/or moving images.

A camera system or the optical system of the camera system is usually equipped with one or more stops as well.

By way of example, a stray light stop reduces stray light in a detection region, that is to say a region upstream of the image sensor.

A field stop limits an imaging light beam to a desired detection region, wherein stray light stops can also be configured as field stops.

A so-called aperture stop defines for example the numerical aperture (NA) and/or a T/# (for lenses for recording moving images, the use of a so-called T-stop or T/# has become established. The latter—like the F/#—is a measure of the image NA, but additionally of the spectral transmittance as well. The number thus becomes more meaningful for the actual exposure of the sensor). The aperture stop is situated in the lens for example at the point where principal rays intersect the optical axis.

The term “imaging light beam” in the present case (as usual) denotes the entire spatial field distribution which converges to form an image.

One problem addressed by the present invention is to propose a device which acts as a stop and which can be used advantageously in a camera system.

### DESCRIPTION

In accordance with one embodiment, a stop module for a camera system is proposed. The camera system comprises a camera unit for capturing still and/or moving images of an object, wherein the camera unit contains the following components arranged along an optical axis of the camera system: an image sensor; a lens, wherein the lens is configured to feed an imaging light beam from the environment encompassing the object to a sensor surface of the image sensor. The stop module is configured for an arrangement, relative to the optical axis, either upstream of the lens, in the lens or between the lens and the image sensor. The stop module has a stop module opening for the imaging light beam and also a multilayered composite construction forming the stop module opening.

In accordance with one embodiment, a stop module for a camera system is proposed. The stop module has a stop module opening for an imaging light beam and also a multilayered composite construction forming the stop module opening.

In accordance with yet another embodiment, a camera system (100) comprises a camera unit for capturing still and/or moving images of an object, wherein the camera unit contains the following components arranged along an optical axis of the camera system: an image sensor; a lens, wherein the lens is configured to feed an imaging light beam from the environment encompassing the object to a sensor surface of the image sensor; a stop module arranged, relative to the optical axis, either upstream of the lens, in the lens or between the lens and the image sensor. The stop module has a stop module opening for the imaging light beam and also a multilayered composite construction forming the stop module opening.

Further features and advantages will become clear to the person skilled in the art in light of studying the following detailed description and looking at the accompanying drawings.

### BRIEF DESCRIPTION OF THE DRAWINGS

The parts shown in the drawings are not necessarily true to scale; rather, the emphasis is on illustrating principles of the invention. Furthermore, in the drawings, identical reference signs denote mutually corresponding parts. In the drawings:

FIG. 1 shows schematically and by way of example a camera system in accordance with one or more embodiments;

FIG. 2 shows schematically and by way of example perspective views of portions (symmetric sectional views) of different stop modules in accordance with some embodiments;

FIG. 3 shows schematically and by way of example cross-sectional views of different stop modules in accordance with some embodiments; and

FIG. 4 shows schematically and by way of example a perspective view of a layer of a stop module in accordance with one or more embodiments.

### DETAILED DESCRIPTION

In the followed detailed description, reference is made to the accompanying drawings, which show how the invention can be implemented in practice through the illustration of specific embodiments.

Reference will now be made in detail to various embodiments and to one or more examples which are illustrated in the figures. Each example is presented in an explanatory manner and should not be interpreted as a restriction of the invention. By way of example, illustrated features or features described as part of one embodiment can be applied to or in association with other embodiments in order to produce yet another embodiment. The present invention is intended to encompass such modifications and variations. The examples are described using a specific language, which should not be interpreted as restricting the scope of protection of the appended claims. The drawings are not a true to scale rendition and serve merely for illustration. In order to afford a better understanding, unless indicated otherwise, the same elements have been identified by the same references in the various drawings.

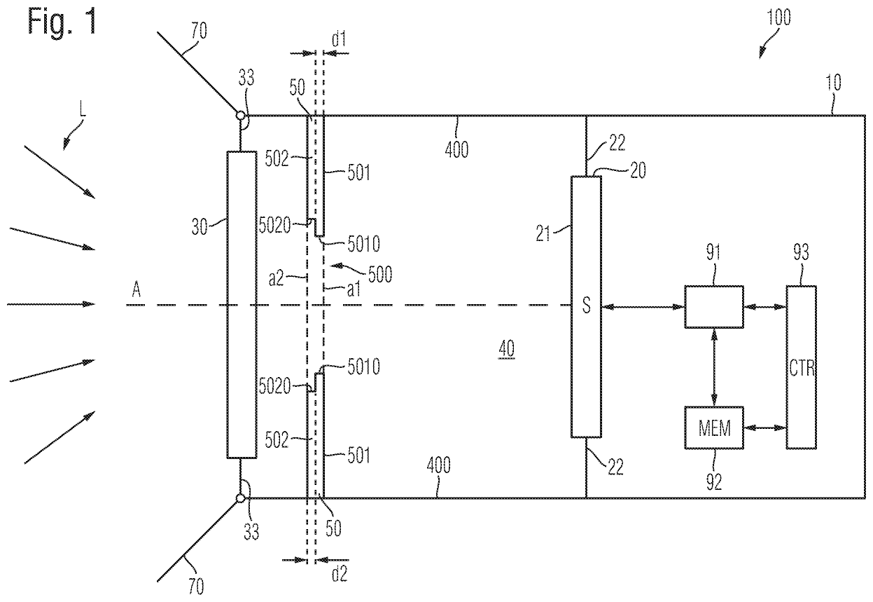

FIG. 1 shows schematically and by way of example one embodiment of a camera system 100.

The camera system 100 described here is configured for example to be used in the context of cinematography, that is to say for example for recording a documentary film, a feature film, a show, other studio presentations and the like. The camera system 100 can be a cinematographic camera system 100.

However, the present invention is not restricted to cinematographic camera systems.

The camera system 100 can for example alternatively be a medical camera system, for example for generating biomedical image recordings.

In principle, consideration is given to all cameral systems, in particular camera optical systems, which can be equipped with a stop module described in detail here (see reference numeral 50). These include for example camera systems for photography and also camera systems for microscopy.

A camera unit 10 of the camera system 100 comprises the customary components of a camera, for example, which are not illustrated in more specific detail or are merely illustrated schematically in the drawings.

The components of the camera system 100 include for example a camera optical system comprising at least one lens 30, a matte box 70, a lens mount (not illustrated), at least one image sensor 20 of the camera unit 10, digital signal processing means, e.g. comprising a read-out unit 91, which reads the image sensor 20 and feeds corresponding data to a digital memory 92, and also a controller 93, which controls the read-out unit 91 and/or the memory 92, a user interface, communication interfaces (not illustrated), etc.

The details of exemplary embodiments of the components 91, 92, 93 disposed downstream of the image sensor 20 will not be discussed more specifically here since the functioning of said components in principle is known to the person skilled in the art.

The camera unit 10 can be configured to be used in the context of cinematography, that is to say for example for recording a documentary film, a feature film, a show, other studio presentations and the like. The camera unit 10 can be a cinematographic camera unit 10. In another embodiment, the camera unit 10 is configured for medical purposes, for example for generating images or image sequences of an object (e.g. a piece of tissue) or the like. As already described above, consideration is given in principle to all camera systems for being equipped with the stop module 50 described here. These include, as stated, for example camera systems for photography and also camera systems for microscopy.

The camera system 100 can be a digital camera system, in which the image data are generated with aid of a digital image sensor 20. However, it is also within the scope of the invention for the image sensor 20 to be present in the form of an analog film that is still occasionally used nowadays. In the camera system configured in this way, the images are thus recorded in an analog manner.

Typically, however, the image sensor 20 is configured as a digital image sensor, for example as a semiconductor chip having a multiplicity of pixels, such as a CMOS or CCD image sensor.

The camera system 100 comprises an image space 40 (which could also be referred to as a lens space), into which the lens 30 couples an imaging light beam L from the environment encompassing the object and feeds it to the image sensor 20, wherein further optical components (besides those not shown here) such as filters, lens elements and the like can be provided between the lens 30 and the image sensor 20.

It goes without saying that different lenses 30 can be attached to the camera unit 10. The components matte box 70, lens 30 and camera unit 10 can thus be produced as separate components. By way of example, various matte boxes 70 can be coupled to the lens 30, various lenses 30 can be coupled to the camera unit 10, and e.g. various camera units 10 can be coupled to the same lens 30. The camera system 100 can thus be constructed modularly.

For coupling the lens 30 to the camera unit 10, a lens mount (not illustrated) can be provided, which can likewise constitute a constituent of the camera system 100. A lens mount can be configured to form a mechanical interface between the lens 30 and the camera unit 10. Lenses from different manufacturers often have different lens-side mount geometries, for which reason the camera-side mounts are interchangeable or modifiable with adapters (intermediate adapters are occasionally used in the field of professional cinematography and in the field of photography).

The image sensor 20 of the camera unit 10 has a sensor surface 21 facing into the image space 40. The sensor surface 21 can be framed by a sensor frame 22, wherein the sensor frame 22 can likewise delimit the image space 40 and adjoins an inner wall 400 of the image space 40 in a flush manner, for example, as is illustrated schematically in FIG. 1.

At the other end, the image space 40 can also be delimited by the lens 30. The lens 30 can be supported by a lens frame 33, which can likewise delimit the image space 40. For the rest, the image space 40 is also delimited by the inner wall 400.

The matte box 70 can be coupled to the lens frame 33 (or to some other point of the camera unit 10 or of the camera system 100).

The image space 40 is illustrated as substantially cylindrical in FIG. 1, wherein in a different embodiment the image space 40 has the shape of a conical section tapering in or counter to the direction of light incidence. Other geometric embodiments of the image space 40 are possible.

FIG. 1 shows a simplified schematic illustration of the camera system 100. The more specific configuration of the camera system 100, insofar as concerns the components 70, 30, 20 and 91-93, is less relevant in the present case. The basic principles of these components are known to the person skilled in the art, and the present invention does not deviate from them.

Apart from the coupling in of the ambient light through the lens 30, the image space 40 can be embodied such that it is substantially lightproof.

The camera system 100 comprising the camera unit 10 for capturing still and/or moving images therefore includes, in particular, the following components arranged along the optical axis A of the camera system 100: the (for example digital) image sensor 20, and the lens 30, which feeds the imaging light beam L from the environment encompassing the object to the sensor surface 21 of the image sensor 20.

Furthermore, in accordance with the embodiments described here, a stop module 50 is provided, which is configured for an arrangement, relative to the optical axis A, either upstream of the lens 30, in the lens 30 or between the lens 30 and the image sensor 20 (as illustrated schematically and by way of example in FIG. 1).

The stop module 50 acts as a stop. It is embodied for example as a stray light stop, a field stop and/or an aperture stop. In particular, the stop module 50 can be embodied as a stray light stop. In particular, the stop module 50, for example in the form of a stray light stop, can be arranged between the lens 30 and the image sensor 20, as illustrated schematically and by way of example in FIG. 1.

Some of the embodiments of the stop module 50 that will now be described are based on the following considerations:

Previously known stray light, field and aperture stops are embodied for example as sheets or sheet assemblies.

In order to disturb an optical system as little as possible, such sheets should be as thin as possible, in particular in a region which touches or adjoins the imaging light beam L. Primarily if the stop edges are illuminated by stray light and are situated in the vicinity of the sensor, they should be as thin as possible.

Illuminated stop edges become all the more visible, the thicker they are, since the stray light irradiance proceeding from the edge is crucially dependent on the illuminated area and the distance thereof with respect to the sensor.

If the stops have a large opening and/or large dimensions, the sheets become difficult to handle during assembly. The sheets are easily damaged, or would have to be made thicker, which would result in optical disadvantages, however, primarily increased occurrence of stray light or an increased visibility of the edges.

On the other hand, thin sheets can act as membranes that are excited by acoustic oscillations, for example as a result of structure-borne sound, which can in turn result in intensified vibrations or evolution of noise.

It is known to produce the sheets from a single material, for example steel or plastic.

What is proposed in the present case is the stop module 50 having a stop module opening 500 for the imaging light beam L, as illustrated schematically in FIG. 1. According to the invention, the stop module 50 has a multilayered composite construction forming the stop module opening 500.

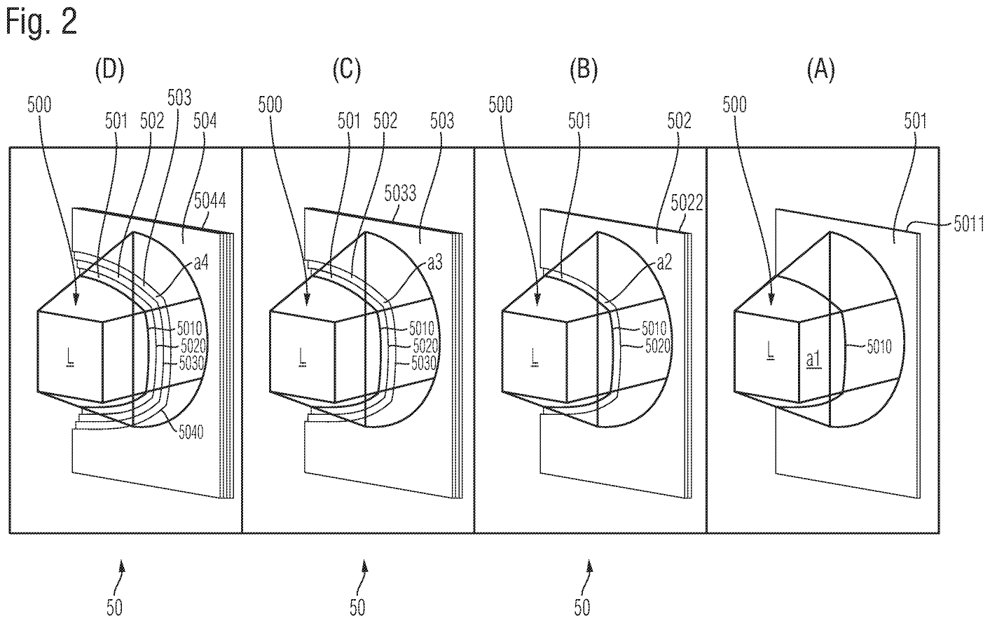

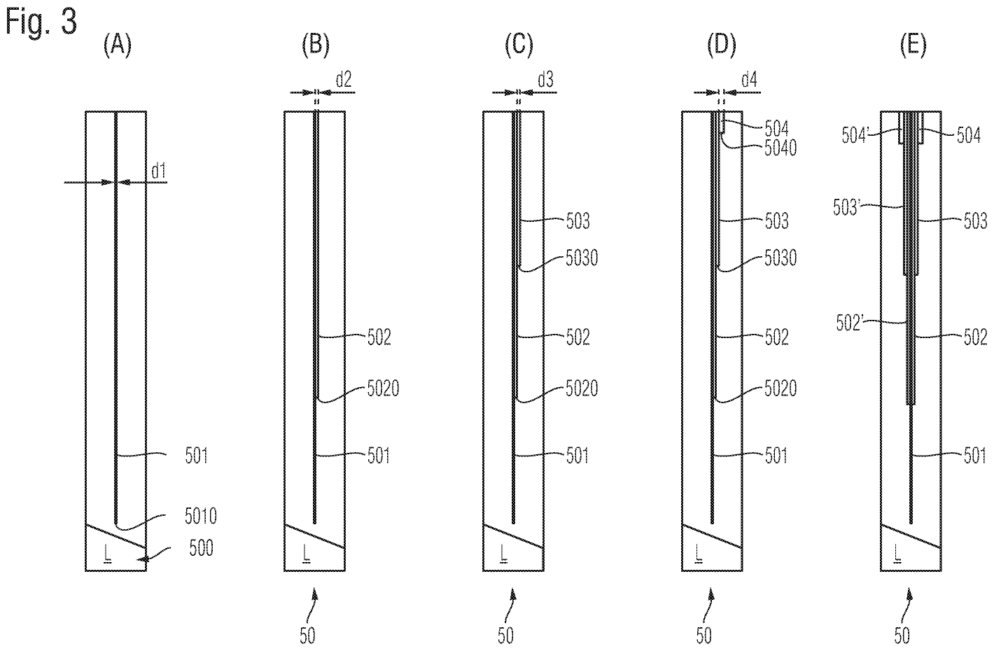

Some exemplary features of said multilayered composite construction will now be explained with reference to FIGS. 2 and 3:

The imaging light beam L illustrated schematically in FIG. 2 usually propagates in a mode volume similar to the illustration therein. In the case of a rotationally symmetrical optical system without field stops, the illuminated area on the image plane (that is to say the sensor surface 21) would be approximately circular, and the illuminance usually decreases toward the inner wall 400/sensor frame 22, that is to say toward the edge. The edge is fluid, for example, and is delimited by vignetting.

In the embodiment in accordance with FIG. 2, the sensor 20 is situated where the light cross-section of the imaging light beam L is rectangular. Contrary to the usual convention and owing to the perspective arrangement, this position of the sensor 20 is thus on the left, relative to the position of the stop module 50.

By means of the stop module 50, the illuminated area can be limited approximately to the sensor surface 21, which is substantially rectangular, for example. Diffraction effects as a result of field and stray light stops are intended to be outside the detection region, for which reason the stop module 50 can be made somewhat larger than the imaging light beam L (on account of the usually low spatial and temporal coherence of the imaging light beam L, in this case a few tenths of a millimeter are sufficient in cinematography applications).

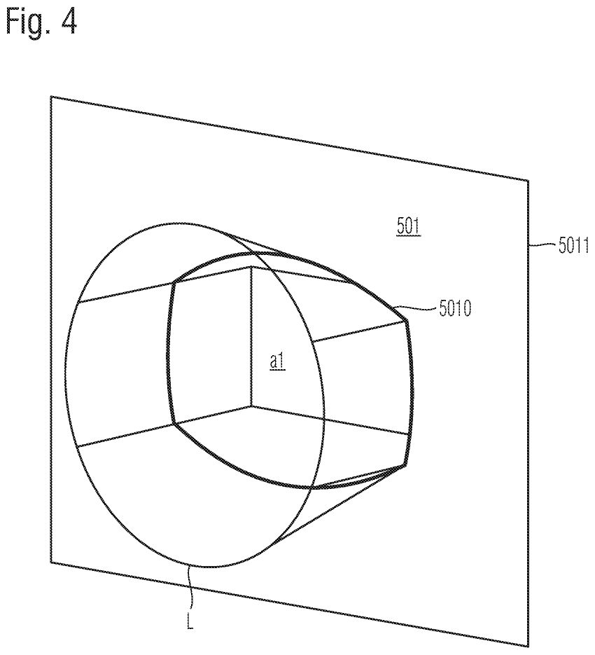

FIG. 2 and FIG. 3 show in the respective part (A) a portion of a first layer 501 of the multilayered composite construction of the stop module 50. The portion shown corresponds approximately to half of the layer 501 (see also FIG. 4)

By means of its edge 5010, the first layer 501 defines the stop module opening 500. For example, the edge 5010 of the first layer 501 is embodied in such a way that it describes the smallest opening a1, in comparison with the openings of the further layers 502 to 504. The opening a1 can be embodied such that it is substantially rectangular, with rounded edges 5010, as illustrated in FIG. 4.

As is furthermore illustrated in part (B) of FIG. 2, the multilayered composite construction can comprise a second layer 502. The two layers 501 and 502 are arranged in a sandwich-like manner, for example, and differ from one another at least in one of the following parameters: in the material; in the layer thickness d1, d2; in the size of the opening a1, a2 for the imaging light beam L.

Consequently, the two layers 501, 502 are not embodied identically to one another. By way of example, the opening a2 defined by the edge 5020 of the second layer 502 is larger than the first opening a1, as illustrated in FIGS. 2 and 3. Furthermore, the second layer 502 can be thicker than the first layer 501, that is to say d2>d1.

From the considerations mentioned above, it may be advantageous to configure the first layer 501 such that it is thin. By way of example, the first thickness d1 is less than/equal to 100 μm, or less than/equal to 50 μm, or less than/equal to 25 μm, or less than/equal to 10 μm.

In accordance with one embodiment, all the layers of the multilayered composite construction have a respective thickness that is substantially uniform across their cross-sectional area. The thickness (which could also be referred to as thickness of the layer) extends parallel to the optical axis A, for example. However, this is not intended to exclude the fact that one or more of the layers can also be structured and/or coated, for example in order to avoid reflections and/or to damp oscillations and/or to foster the composite, as will be explained in even greater detail further below.

The thickness d2 of the second layer 502 can be chosen to be greater, for example greater than 50 μm, or greater than 100 μm, 200 μm or 500 μm. The mechanical stability of the stop module can thus be improved by the second layer 502, whereas the (thin) first layer 501 results in advantageous optical properties.

Furthermore, provision can be made for the first layer 501 and the second layer 502 to have the same outer peripheral course 5011, 5022. Optional further layers 503, 504 and also 502′, 503′ and 504′ (see FIG. 3 (E)) can also all have an outer peripheral course 5033, 5044 that is identical to the outer peripheral course 5011 of the first layer 501. This can simplify the arrangement, that is to say the installation of the stop module 50 in the camera system 100.

All of the layers of the multilayered composite construction of the stop module 50 can be embodied monolithically in each case. The layers can be adhesively bonded, soldered, latched and/or welded to one another in order to form the multilayered composite construction of the stop module 50. In accordance with one embodiment, the multilayered composite construction itself is however not embodied monolithically.

The stop module 50 can comprise an adhesive, for example a resin, a silicone and/or a polyurethane, for connecting adjacent layers of the multilayered composite construction.

Additionally or alternatively, for connecting adjacent layers of the multilayered composite construction, at least one layer of the multilayered composite construction can have at least one structured layer side. This structuring can enable or at least foster e.g. a latching of adjacent layers. The structuring, for example including one or more defined cutouts (besides the opening a1; a2; a3; a4), can furthermore contribute to damping oscillations.

In accordance with a further embodiment, the multilayered composite construction (apart from the stop module opening 500, of course) is embodied such that it is light-nontransmissive. The layers 501 etc. of the multilayered composite construction are embodied such that they are light-nontransmissive, for example.

The stop module 50 is arranged in the camera system 100 for example in such a way that that layer (for example the first layer 501) of the multilayered composite construction which is the innermost layer or the layer situated closest to the image sensor 20 is the thinnest of all the layers of the multilayered composite construction. Consequently, e.g. the edge 5010 of this thinnest layer is also comparatively thin and thus couples in no or at most little stray light.

As already described further above, provision can furthermore be made for that layer (for example the first layer 501) of the multilayered composite construction which is the innermost layer or the layer situated closest to the image sensor 20 to have the smallest opening a1 for the imaging light beam L in comparison with the other layers of the multilayered composite construction. Said smallest opening a1, that is to say the edge 5010 of that layer (for example the first layer 501) which is the innermost layer or the layer situated closest to the image sensor 20, thus defines the stop module opening 500. All other openings of the (e.g. thicker) other layers are chosen to be larger, and these layers can be arranged such that their edges 5020, 5030 etc. do not restrict the smallest opening a1 as illustrated in FIG. 2 and in FIG. 3. In accordance with embodiments, these layers can furthermore be arranged such that the aperture edges are not illuminated at all (cf. e.g. layers in FIGS. 3 B, C & D; the first layer 501 in each case covers the aperture edges of the other layer(s)), and/or such that illuminated edges cannot scatter directly, that is to say without further reflections, to the sensor 20 (cf. e.g. the layers 504′, 503′, 502′ facing the light L in FIG. 3 E).

One of the layers of the multilayered composite construction, e.g. the first layer 501, which is the thinnest layer of all the layers, for example, can be produced e.g. from a thin sheet or a silicon wafer.

Another of the layers of the multilayered composite construction, e.g. the second layer 502, which is somewhat thicker than the thinnest layer, for example, can be produced e.g. from a fiber composite material.

Referring to FIGS. 2 and 3 again, in accordance with a further embodiment, see variant (C), provision can be made for the multilayered composite construction to have a third layer 503. Said third layer 503 can be thicker (d3) than the first layer 501 (d1) and also thicker than the second layer 502 (d2), and the third opening a3 defined by its edge 5030 can be larger than the first opening a1 and also larger than the second opening a2.

In accordance with yet another embodiment, see variant (D), provision can be made for the multilayered composite construction to have a fourth layer 504. Said fourth layer 504 can be thicker (d4) than the first layer 501 (d1) and also thicker than the second layer 502 (d2), and even thicker than the third layer 503 (d3), and the fourth opening a4 defined by its edge 5040 can be larger than the first opening a1, the second opening a2 and larger than the third opening a3.

In order to form the multilayered composite construction, in accordance with one embodiment, sheets (or layers composed of different materials) having an opening that becomes larger are thus stacked and connected. In this case, as explained, provision can be made for the thickness, for example the sheet thickness, of the outer layers to increase, e.g. in order, given the thinnest possible thickness d1 of the first layer 501 adjoining the imaging light beam L, to increase the dimensional stability and to reduce the influence on acoustic oscillations.

As explained, some embodiments provide that, in proximity to the sensor 20, the thickness of the layer adjoining the imaging light beam L (e.g. the first layer 501, thickness d1) is less than or equal to 50 μm, or even less than or equal to 25 μm.

The individual gradations of the multilayered composite construction of the stop module 50 can e.g. face in the direction of the sensor 20 (according to which the first layer 501 would be the furthest away from the sensor 20) or face in the direction of the lens 30 (according to which the first layer 501 would be the closest to the sensor 20 in comparison with the other layers). The multilayered composite construction parallel to the optical axis A can thus have an asymmetrical structure, as illustrated in FIGS. 2 and 3, variants (B) to (D).

As illustrated in FIG. 3, variant (E), however, combinations of these approaches are possible, according to which the gradations of the multilayered composite construction face in both directions, that is to say both in the direction of the sensor 20 and in the direction of the lens 30. In particular, a symmetrical coating is possible for forming the multilayered composite construction, according to which the first layer 501 is the innermost layer of the multilayered composite construction, and is fitted from both sides with second layers 502, 502′, third layers 503, 503′ and/or fourth layers 504, 504′. The symmetrical construction can be advantageous, e.g. in order to compensate for possible warpage as a result of internal stresses.

In order to form the multilayered composite construction, the individual layers can be produced in various ways, depending on the semifinished product, for example additively printed, cut out and laminated, jet/beam cut (for example water or laser) or etched. The individual layers can be connected by various manufacturing methods depending on the type of material, for example laser fine welding, resistance spot welding, soldering, adhesive bonding and the like.

As likewise explained further above, the various layers can furthermore consist of the same material or else different materials. The first layer 501 is produced from a thin sheet or semiconductor wafer, for example. By way of example, the second and/or third and/or fourth layer 502 (502′), 503 (503′), 504 (504′) can consist of fiber composite materials (for example carbon or glass fiber in epoxy resin or PEEK matrix), which have vibration-damping properties with at the same time reduction of weight and high stiffness and strength.

In accordance with yet another embodiment, one, a plurality or all of the layers of the multilayered composite construction can at least partly be produced from a semiconductor wafer, e.g. be embodied as a silicon wafer that has optionally been processed further. The respective aperture (openings a1 to a4) can (as also in the case of a thin sheet/metal) be etched into the semiconductor wafer and the other semiconductor wafer surfaces (e.g. silicon surfaces) can be blackened wet-chemically. So-called black silicon, in particular, can be used in this context. By way of example, the silicon wafer(s) (or wafer(s) composed of some other semiconductor material) is/are etched to a geometric shape and the light absorption properties are set by means of (for example wet-chemical) etching processes.

Adhesives for connection to the adjacent layers can be, for example, epoxy resins, silicones or else polyurethanes, which can additionally be used for damping oscillations; including in foamed form. The outer layers, e.g. the second and/or third and/or fourth layer 502 (502′), 503 (503′), 504 (504), in particular the inner first layer 501 adjoining the imaging light beam L, can be embodied as spring steel thin sheets, for example composed of 1.4310 or 1.4301, and can be welded to one another, e.g. by means of through holes in the inner layers composed of fiber composite materials.

Furthermore, the layers in the outer region of the composite construction (e.g. the second and/or third and/or fourth layer 502 (502′), 503 (503′), 504 (504)) can additionally be shaped in order to further increase the dimensional stability, for example by means of ground indentations or embossings. This additional deformation/structuring can also be used for connecting the layers.

In accordance with yet another embodiment, the layers 501 to 504 as a composite can be provided with a surface coating, for example with Acktar Magic Black, Avian Black-S, Surrey Nanosystems S-VIS coatings or VBx coating or a black antifriction coating. The layers 501 to 504 can also be separately provided with respectively optimized coatings. The coatings can be embodied as a specularly or diffusely reflective absorber (or reflector). In the case where at least one of the layers 501 to 504 is embodied on the basis of a semiconductor wafer, e.g. silicon wafer, in order to form the surfaces it is possible to implement said wet-chemical processes, e.g. wet-chemical blackening processes.

The structured layer side in the case of at least one of the layers, as discussed further above, can be embodied e.g. in such a way that resonant oscillation modes in the relevant acoustic frequency excitation range (approximately 10 Hz to 500 Hz) are damped or prevented by defined cutouts in the relevant layers.

Some of the embodiments of the stop module 50 described here allow reduction of the visibility of the edges of field and stray light stops through to invisibility in conjunction with simple handlability during assembly. Primarily for stops in proximity to the sensor or for the aperture stop, the thinnest possible embodiment is important in the case of a high image dynamic range. Moreover, some of the embodiments of the stop module 50 described here reduce possible disturbances as a result of acoustic oscillations.

As used here, the terms “having”, “containing”, “including”, “encompassing”, “comprising” and the like are open terms which indicate the presence of elements or features mentioned, but do not exclude additional elements or features.

In view of the above range of variations and applications, it is pointed out that the present invention is not restricted by the description above, nor is it restricted by the accompanying drawings. Rather, the present invention is restricted only by the following claims and the legal equivalents thereof.

1. A stop module for a camera system, the camera system comprising a camera unit for capturing still and/or moving images of an object, wherein the camera unit contains the following components arranged along an optical axis of the camera system:
an image sensor;
a lens, wherein the lens is configured to feed an imaging light beam from the environment encompassing the object to a sensor surface of the image sensor; wherein the stop module
is configured for an arrangement, relative to the optical axis, upstream of the lens, in the lens or between the lens and the image sensor;
has a stop module opening for the imaging light beam; and
has a multilayered composite construction forming the stop module opening.

2. The stop module as claimed in claim 1, wherein the multilayered composite construction of the stop module comprises a first layer and also a second layer, which are arranged in a sandwich-like manner and differ from one another at least in one of the following parameters: material; layer thickness; size of the opening for the imaging light beam.

3. The stop module as claimed in claim 2, wherein the first layer has a thickness of less than 50 μm.

4. The stop module as claimed in claim 2, wherein the second layer has a thickness of more than 50 μm.

5. The stop module as claimed in claim 2, wherein the first layer and the second layer have the same outer peripheral course.

6. The stop module as claimed in claim 2, wherein the first layer and the second layer are embodied in each case from a monolithic layer and/or wherein the first layer and the second layer are adhesively bonded, soldered, latched and/or welded to one another.

7. The stop module as claimed in claim 1, wherein a layer of the multilayered composite construction that is an innermost layer or a layer closest to the image sensor is the thinnest of all the layers of the multilayered composite construction.

8. The stop module as claimed in claim 1, wherein a layer of the multilayered composite construction that is an innermost layer or a layer closest to the image sensor has the smallest opening for the imaging light beam in comparison with the other layers of the multilayered composite construction.

9. The stop module as claimed in claim 1, wherein one of the layers of the multilayered composite construction is produced from a fiber composite material.

10. The stop module as claimed in claim 1, wherein one of the layers of the multilayered composite construction is produced from a thin sheet.

11. The stop module as claimed in claim 1, wherein the stop module forms a stray light stop, a field stop and/or an aperture stop.

12. The stop module as claimed in claim 1, wherein the stop module is configured for an arrangement between the lens and the image sensor.

13. The stop module as claimed in claim 1, wherein the stop module comprises an adhesive, for example a resin, a silicone or a polyurethane, for connecting adjacent layers of the multilayered composite construction.

14. The stop module as claimed in claim 1, wherein at least one layer of the multilayered composite construction has at least one structured layer side.

15. The stop module as claimed in claim 1, wherein at least one layer of the multilayered composite construction has an absorbent or reflective surface coating.

16. The stop module as claimed in claim 1, wherein at least one layer of the multilayered composite construction has one or more cutouts besides the opening.

17. The stop module as claimed in claim 1, wherein at least one layer of the multilayered composite construction is at least partly produced from a semiconductor wafer.

18. A stop module for a camera system, wherein the stop module has a stop module opening for an imaging light beam and also a multilayered composite construction forming the stop module opening.

19. A camera system, the camera system comprising a camera unit for capturing still and/or moving images of an object, wherein the camera unit contains the following components arranged along an optical axis of the camera system:
an image sensor;
a lens, wherein the lens is configured to feed an imaging light beam from the environment encompassing the object to a sensor surface of the image sensor;
a stop module arranged, relative to the optical axis, either upstream of the lens, in the lens or between the lens and the image sensor, wherein the stop module
has a stop module opening for the imaging light beam; and
has a multilayered composite construction forming the stop module opening.
